(19) United States
(12) Patent Application Publication
(10) Pub. No.: US 2008/0058992 A1
(43) Pub. Date: Mar. 6, 2008

(54) Floodgate Opening and Closing System Using Measurement of Motor Revolution Count

(76) Inventors: Jong Yul AN, Naju-si (KR); Soung Ho Kil, Seoul (KR)

Correspondence Address: PARK LAW FIRM, 3255 WILSHIRE BLVD, SUITE 1110, LOS ANGELES, CA, 90010, US

(21) Appl. No.: 11/780,035

(22) Filed: Jul. 19, 2007

(30) Foreign Application Priority Data
Sep. 4, 2006 (KR) 10-2006-0084795

(51) Int. Cl. G05B 13/02; E02B 7/16

(52) U.S. Cl. 700/275; 405/87

(57) ABSTRACT

Disclosed is a floodgate opening and closing system using a measurement of a motor revolution count, in that an opening and closing state of a floodgate formed at irrigation facilities for sewage, rainwater, agricultural water, freshwater and so on can be numerically transformed and the transformed data can be transmitted to a data collection apparatus such as a remote control system or transmission system and so forth through a communication network and so on, so that the opening and closing rate of the floodgate can be exactly perceived and controlled in a real-time on the remote place, whereby increasing the efficiency of water management.

### BACKGROUND OF THE INVENTION

1. Field of the Invention

The present invention relates to a floodgate opening and closing system using a measurement of a motor revolution count, and more particularly to a floodgate opening and closing system using a measurement of a motor revolution count, in that an opening and closing state of a floodgate formed at irrigation facilities for sewage, rainwater, agricultural water, freshwater and so on can be numerically transformed and the transformed data can be transmitted to a data collection apparatus such as a remote control system or transmission system and so forth through a communication network and so on, so that the opening and closing rate of the floodgate can be exactly perceived and controlled in a real-time on the remote place, whereby increasing the efficiency of water management.

2. Description of the Prior Art

Generally, a dam or a reservoir for irrigation is built in the irrigation facilities in order to ensure a life water, industrial water, agricultural water and so on.

A floodgate having an opening and closing apparatus of water is formed at the dam or a reservoir for irrigation. As occasion demands, the floodgate is opened or closed to regulate the volume of water.

Conventionally, a control handle is mounted to the floodgate, so that the opening and closing thereof is manually controlled by the rotation of the control handle.

However, recently, by using motor and gear units or hydraulic piston apparatus and so forth, the opening and closing thereof can be automatically controlled in the main.

The opening and closing state of the conventional floodgate is displayed and calculated by the control time of the motor.

However, in the conventional floodgate, since the control of the water supply is determined by the subject of the specific manager, it is very difficult to control the proper water supply.

Also, presently, in case that the agricultural water is supplied to a farmhouse, since it is manually controlled, the water supply or the period thereof cannot be quantitatively stored as a database.

### SUMMARY OF THE INVENTION

Accordingly, the present invention has been made to solve the above-mentioned problems occurring in the prior art, and an object of the present invention is to provide a floodgate opening and closing system using a measurement of a motor revolution count in that opening and closing of the floodgate can be exactly and numerically controlled in a real-time on the remote place and the numerical data can be transmitted to the remote place in order to check it.

To accomplish the object, the present invention provides a floodgate opening and closing system using a measurement of a motor revolution count comprising: a floodgate opening and closing motor for opening and closing a floodgate according to an operation of a user; a motor revolution counter for counting a revolution count of the floodgate opening and closing motor during floodgate opening and closing; a motor revolution accumulation counter for counting an accumulated revolution count of the floodgate opening and closing motor; a storage portion for storing a maximum revolution count of the floodgate opening and closing motor during complete opening of the floodgate; an opening and closing rate calculating portion for calculating an opening and closing rate of the floodgate; a motor revolution remaining counter for counting a remaining revolution count of the floodgate opening and closing motor by calculating the opening and closing rate; and a CPU(central processing unit) for controlling each component by and large electrically connected to the components.

Preferably, the floodgate opening and closing system further comprises a display portion for checking out the opening and closing rate calculated from the opening and closing rate calculating portion on the spot.

Preferably, in the opening and closing rate calculating portion, the opening and closing rate is calculated by dividing the accumulated revolution count of the motor revolution accumulation counter by the maximum revolution count of the storage portion and multiplying it by 100.

Preferably, the floodgate opening and closing system further comprises a data transmission portion for receiving an operation signal of the user from the remote place and transmitting a data calculated through the operation of the floodgate opening and closing to the remote place

### BRIEF DESCRIPTION OF THE DRAWINGS

The above as well as the other objects, features and advantages of the present invention will be more apparent from the following detailed description taken in conjunction with the accompanying drawings, in which:

FIG. 1 is an entire block diagram illustrating a floodgate opening and closing system using a measurement of a motor revolution count according to the present invention.

FIG. 2 is a block diagram illustrating a floodgate opening and closing system using a measurement of a motor revolution count according to the present invention; and

FIG. 3 is an example view illustrating an operation of the floodgate opening and closing system using a measurement of a motor revolution count according to the present invention.

### DETAILED DESCRIPTION OF THE PREFERRED EMBODIMENTS

A preferred embodiment of the invention will be described in detail below with reference to the accompanying drawings.

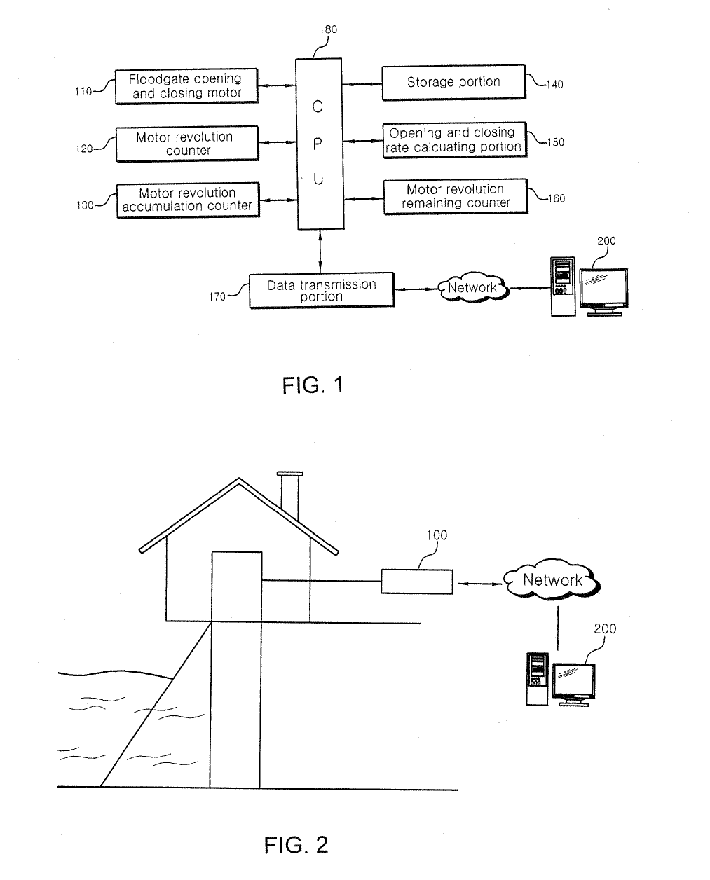

FIG. 1 is an entire block diagram illustrating a floodgate opening and closing system using a measurement of a motor revolution count according to the present invention.

As shown in FIG. 1, the floodgate opening and closing system 100 using the measurement of the motor revolution count according to the present invention is mounted at a motor 100 for opening and closing the floodgate, so that the motor 110 can be directly operated on the spot or the motor 110 can be operated according to the handling of the computer terminal 200 of the user on a remote place.

Here, in order to directly operate the motor on the spot, a separate controller of operator (not shown) can be formed at the floodgate opening and closing system.

In conventional floodgate opening and closing system using the detection of the sensor, the badness thereof is originated from the inaccurate opening and closing rate. However, the opening and closing rate of floodgate can be exactly calculated and the exact opening and closing of floodgate can be executed on the remote place or spot through the floodgate opening and closing system according to the present invention.

FIG. 2 is a block diagram illustrating a floodgate opening and closing system using a measurement of a motor revolution count according to the present invention.

As shown in FIG. 2, the floodgate opening and closing system 100 using the measurement of the motor revolution count according to the present invention includes a floodgate opening and closing motor 110 for opening and closing a floodgate according to an operation of a user; a motor revolution counter 120 for counting the revolution count of the floodgate opening and closing motor 110 during floodgate opening and closing; a motor revolution accumulation counter 130 for counting an accumulated revolution count of the floodgate opening and closing motor 110; a storage portion 140 for storing a maximum revolution count of the floodgate opening and closing motor 110 during complete opening of the floodgate; an opening and closing rate calculating portion 150 for calculating an opening and closing rate of the floodgate; a motor revolution remaining counter 160 for counting the remaining revolution count of the floodgate opening and closing motor 110 by calculating the opening and closing rate; and a CPU (central processing unit) 180 for controlling each component by and large electrically connected to the components.

Also, the floodgate opening and closing system according to the present invention further includes a display portion for checking out the opening and closing rate calculated from the opening and closing rate calculating portion 150 on the spot.

Moreover, in the opening and closing rate calculating portion 150, the opening and closing rate is calculated by dividing the accumulated revolution count of the motor revolution accumulation counter by the maximum revolution count of the storage portion and multiplying it by 100.

Furthermore, the floodgate opening and closing system according to the present invention further includes a data transmission portion 170 for receiving an operation signal of the user from the remote place and transmitting a data calculated through the operation of the floodgate opening and closing to the remote place.

Here, the floodgate opening and closing motor 110 can be operated according to the opening and closing rate and the remaining revolution count of the motor revolution remaining counter 160.

By means of the opening and closing rate calculating portion 150, the opening and closing rate is calculated by dividing the accumulated revolution count of the motor revolution accumulation counter by the maximum revolution count of the storage portion and multiplying it by 100 as follows.

Y(%)=100*(Z/X)

(Here, X is a maximum revolution count of the floodgate opening and closing motor during complete opening (100%) of the floodgate, Y is an opening and closing rate, and Z is an accumulated revolution count of the motor revolution accumulation counter).

For example, where X is 100,000 and Z is 20,000, Y becomes 20%.

Here, the maximum revolution count stored in the storage portion 140 can be varied according to the place thereof.

Also, according to another aspect of the present invention, the floodgate opening and closing system according to the present invention is provided with the data transmission portion for receiving the operation signal of the user from the remote place and transmitting the data calculated through the operation of the floodgate opening and closing to the remote place, so that the data operated from the remote place can be transmitted to the floodgate opening and closing system of the actual spot and the performed data can be transmitted to the remote place by means of the remote control.

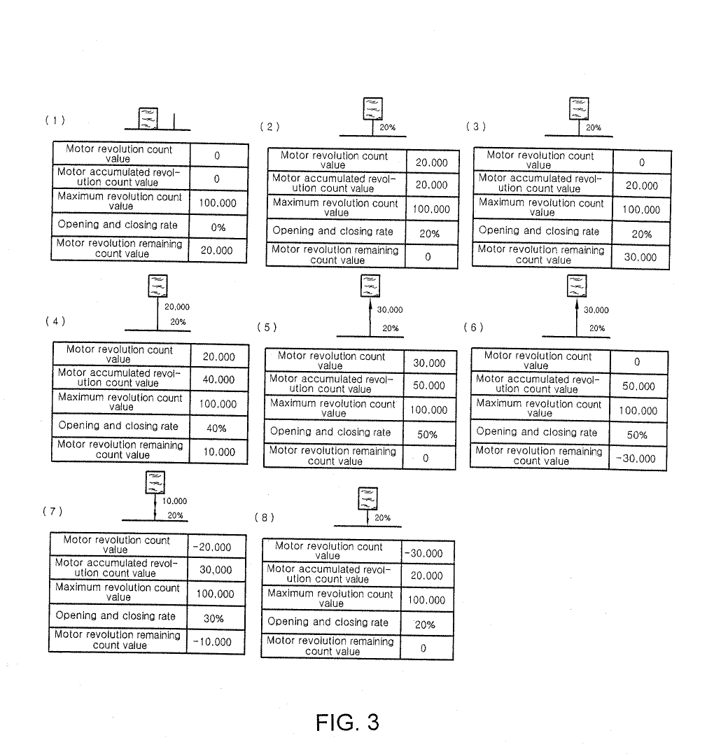

The operation of each component will be described in detail below with reference to FIG. 3.

FIG. 3 is an example view illustrating an operation of the floodgate opening and closing system using a measurement of a motor revolution count according to the present invention.

Firstly, as shown in FIG. 3(1), the first motor revolution count value is “0”, the motor accumulated revolution count is “0”, and the maximum revolution count stored in the storage portion 140 is “100,000”. Here, if a floodgate opening order of 20% is issued, the opening and closing rate is “o” and the motor revolution remaining counter 160 counts “20,000” as a motor revolution remaining count.

Continuously, according to the floodgate opening order of 20%, as shown in FIG. 3(2), the value of the motor revolution counter is “20,000”, the value of the motor accumulated revolution counter is “20,000”, the maximum revolution count stored in the storage portion is “100,000”, the opening and closing rate of the opening and closing rate calculating portion 150 is “20%”, and the value of the motor revolution remaining counter is “0”. Here, when the opening order is completely performed, the system returns to an initial state.

Here, where an additional floodgate opening order of 30,000 revolutions is issued, the value of the motor revolution counter is “0”, the value of the motor accumulated revolution counter is “20,000”, the maximum revolution count stored in the storage portion is “100,000”, the opening and closing rate of the opening and closing rate calculating portion 150 is “20%”, and the value of the motor revolution remaining counter is “30,000” as shown in FIG. 3(3). Continuously, as shown in FIG. 3(4), the value of the motor revolution counter is “20,000”, the value of the motor accumulated revolution counter is “40,000”, the maximum revolution count stored in the storage portion is “100,000”, the opening and closing rate of the opening and closing rate calculating portion is “40%”, and the value of the motor revolution remaining counter is “10,000” in the course of the order performance. Finally, as shown in FIG. 3(5), the value of the motor revolution counter is “30,000”, the value of the motor accumulated revolution counter is “50,000”, the maximum revolution count stored in the storage portion is “100,000”, the opening and closing rate of the opening and closing rate calculating portion is “50%”, and the value of the motor revolution remaining counter is “0”. Here, when the opening order is completely performed, the system returns to an initial state.

On the contrary, when a floodgate closing order of 30,000 revolutions is issued by the user, the value of the motor revolution counter is “0”, the value of the motor accumulated revolution counter is “50,000”, the maximum revolution count stored in the storage portion is “100,000”, the opening and closing rate of the opening and closing rate calculating portion is “50%”, and the value of the motor revolution remaining counter is “−30,000” as shown in FIG. 3(6). Continuously, as shown in FIG. 3(7), the value of the motor revolution counter is “−20,000”, the value of the motor accumulated revolution counter is “30,000”, the maximum revolution count stored in the storage portion is “100,000”, the opening and closing rate of the opening and closing rate calculating portion is “30%”, and the value of the motor revolution remaining counter is “−10,000” in the course of the order performance. Finally, as shown in FIG. 3(8), the value of the motor revolution counter is “−30,000”, the value of the motor accumulated revolution counter is “20,000”, the maximum revolution count stored in the storage portion is “100,000”, the opening and closing rate of the opening and closing rate calculating portion is “20%”, and the value of the motor revolution remaining counter is “0”. Here, when the closing order is completely performed, the system returns to an initial state.

In case of minus (−) values in FIG. 3, it means a opposite revolution of the motor.

The opening/closing order can be issued as a revolution number or as opening and closing rate.

By means of the floodgate opening and closing system using the measurement of the motor revolution count according to the present invention, the opening and closing of the floodgate can be exactly and numerically controlled in a real-time on the remote place and the numerical data can be transmitted to the remote place in order to check it.

While this invention has been described in connection with what are presently considered to be the most practical and preferred embodiments, it is to be understood that the invention is not limited to the disclosed embodiments and the drawings, but, on the contrary, it is intended to cover various modifications and variations within the spirit and scope of the appended claims.

As can be seen from the foregoing, in the floodgate opening and closing system using the measurement of the motor revolution count according to the present invention, the opening and closing rate of the floodgate can be exactly checked out, the amount of water discharged through the floodgate can be exactly calculated, and the database is established on the basis of the calculated water supply and harvest that year, so that the agricultural technology can be more developed and the water can be efficiently managed, thereby solving the lack problem of water and decreasing the budget for water management.

What is claimed is:

1. A floodgate opening and closing system using a measurement of a motor revolution count comprising:
a floodgate opening and closing motor for opening and closing a floodgate according to an operation of a user;
a motor revolution counter for counting a revolution count of the floodgate opening and closing motor during floodgate opening and closing;
a motor revolution accumulation counter for counting an accumulated revolution count of the floodgate opening and closing motor;
a storage portion for storing a maximum revolution count of the floodgate opening and closing motor during complete opening of the floodgate;
an opening and closing rate calculating portion for calculating an opening and closing rate of the floodgate;
a motor revolution remaining counter for counting a remaining revolution count of the floodgate opening and closing motor by calculating the opening and closing rate; and
a CPU (central processing unit) for controlling each component by and large electrically connected to the components.

2. A floodgate opening and closing system using a measurement of a motor revolution count as claimed in claim 1, further comprising a display portion for checking out the opening and closing rate calculated from the opening and closing rate calculating portion on the spot.

3. A floodgate opening and closing system using a measurement of a motor revolution count as claimed in claim 1, wherein in the opening and closing rate calculating portion, the opening and closing rate is calculated by dividing the accumulated revolution count of the motor revolution accumulation counter by the maximum revolution count of the storage portion and multiplying it by 100.

4. A floodgate opening and closing system using a measurement of a motor revolution count as claimed in claim 1, further comprising a data transmission portion for receiving an operation signal of the user from the remote place and transmitting a data calculated through the operation of the floodgate opening and closing to the remote place.
